(19) United States
(12) Patent Application Publication
(10) Pub. No.: US 2010/0314508 A1
(43) Pub. Date: Dec. 16, 2010

(54) Apparatus with flexible tripod and electronic device

(76) Inventors: JOEBEN BEVIRT, Santa Cruz, CA (US); KENNETH MINN, San Francisco, CA (US)

Correspondence Address: MICHAEL A. GUTH, 2-2905 EAST CLIFF DRIVE, SANTA CRUZ, CA, 95062, US

(21) Appl. No.: 11/895,020

(22) Filed: Aug. 22, 2007

Related U.S. Application Data
(63) Continuation-in-part of application No. 11/324,994, filed on Jan. 3, 2006.
Application No. 11/324,994 is a continuation-in-part of application No. 11/637,611, filed on Dec. 12, 2006.
Application No. 11/637,611 is a continuation-in-part of application No. 11/324,994, filed on Jan. 3, 2006.

(51) Int. Cl. F16M 11/04; F16M 11/24; F16C 11/06

(52) U.S. Cl. 248/121; 248/440.1; 403/122

(57) ABSTRACT

A flexible support apparatus, such as a tripod, supporting an electronic device, such as a personal video player. The flexible tripod may include ball and socket joint connectors which, when interconnected, form a flexible assembly. The flexible support apparatus allows the user to view the device in a variety of locations with enhanced ease, comfort, and allows for a variety of viewing angles.

### CROSS-REFERENCE TO RELATED APPLICATIONS

This application is a continuation in part of U.S. application Ser. No. 11/637,611 to Bevirt et al., which is a is a continuation in part of U.S. patent application Ser. No. 11/324,994 to Bevirt, filed Jan. 3, 2006, which are both hereby incorporated by reference in their entirety.

### BACKGROUND

1. Field of the Invention

The present invention relates to a flexible support apparatus, such as a tripod, adapted to support an electronic item such as a video player.

2. Description of Related Art

Typical tripod assemblies consist of three rigid legs which are splayed out to form a support structure for devices such as cameras. The legs are usually rigid and adapted to provide support off of the ground or other flat surface. Some tripods have some adjustment to leg length which may allow for some deviation from flatness in the surface upon which they are mounted.

Such tripods are limited in the manner in which they support devices such as cameras. What is called for is a mounting apparatus that may function as a tripod and also as a grip mount for the mounting to vertical members.

### SUMMARY

The present invention is directed towards a flexible support apparatus, such as a tripod, supporting an electronic device, such as a personal video player. The flexible tripod may include ball and socket joint connectors which, when interconnected, form a flexible assembly. The flexible support apparatus allows the user to view the device in a variety of locations with enhanced ease, comfort, and allows for a variety of viewing or use angles.

### BRIEF DESCRIPTION OF THE DRAWINGS

FIGS. 1A-E illustrate an electronic device according to some embodiments of the present invention.

FIGS. 2A-D illustrate an electronic device mounted to a flexible tripod according to some embodiments of the present invention.

FIGS. 3A-C illustrate a device mount according to some embodiments of the present invention.

FIGS. 4A-B illustrate an electronic device mounted into a device mount according to some embodiments of the present invention.

FIGS. 5A-B illustrate a flexible support structure according to some embodiments of the present invention.

FIGS. 6A-C illustrate an apparatus assembled from an electronic device mounted in a mount attached to a flexible tripod 20.

FIGS. 7A-D illustrate an apparatus assembled from an electronic device with an integral clip mounted onto a flexible tripod according to some embodiments of the present invention.

FIG. 8 is a side view of a flexible leg according to some embodiments of the present invention.

FIG. 9 is an end view of a flexible leg according to some embodiments of the present invention.

FIG. 10 is a cross-sectional view of a flexible leg according to some embodiments of the present invention.

FIGS. 11 and 11A are a side and cross-sectional view of a connector according to some embodiments of the present invention.

FIG. 12 is a side view of a connector according to some embodiments of the present invention.

FIGS. 13 and 13A are a side and cross-sectional view of a connector according to some embodiments of the present invention.

FIG. 14 is a picture of a flexible tripod holding a video player according to some embodiments of the present invention.

FIG. 15 is a picture of a flexible tripod holding a video player according to some embodiments of the present invention.

### DETAILED DESCRIPTION

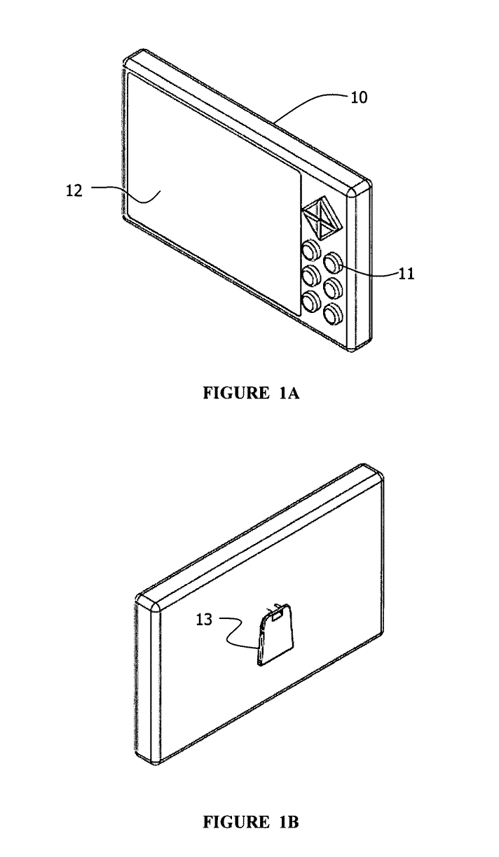

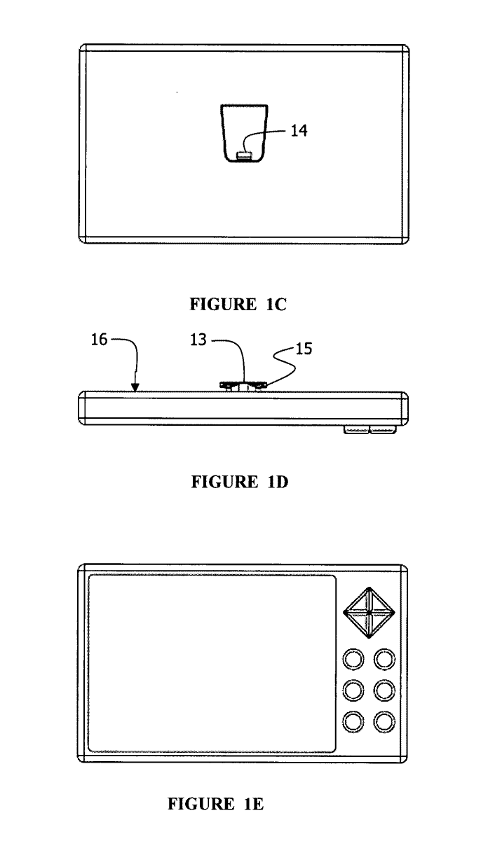

FIGS. 1A-E illustrate an electronic device 10 according to some embodiments of the present invention. In some embodiments, the electronic device is a video player. The electronic device may also be a GPS device, a remote monitor, or other device. The electronic device may have a screen 12 and control features 11.

In some embodiments, the electronic device 10 has a mounting clip 13 mounted to its back surface 16. The mounting clip 13 is adapted to clip into a support structure such as a tripod, or a flexible tripod. The clip 13 may have a recess 14 on its bottom surface adapted to receive a tab from its mating interface. The clip 13 may have rails 15 around some of its bottom edges adapted to mate into the receiver of the support structure. In some embodiments, the clip may be mounted to a different surface or edge of the electronic device 10.

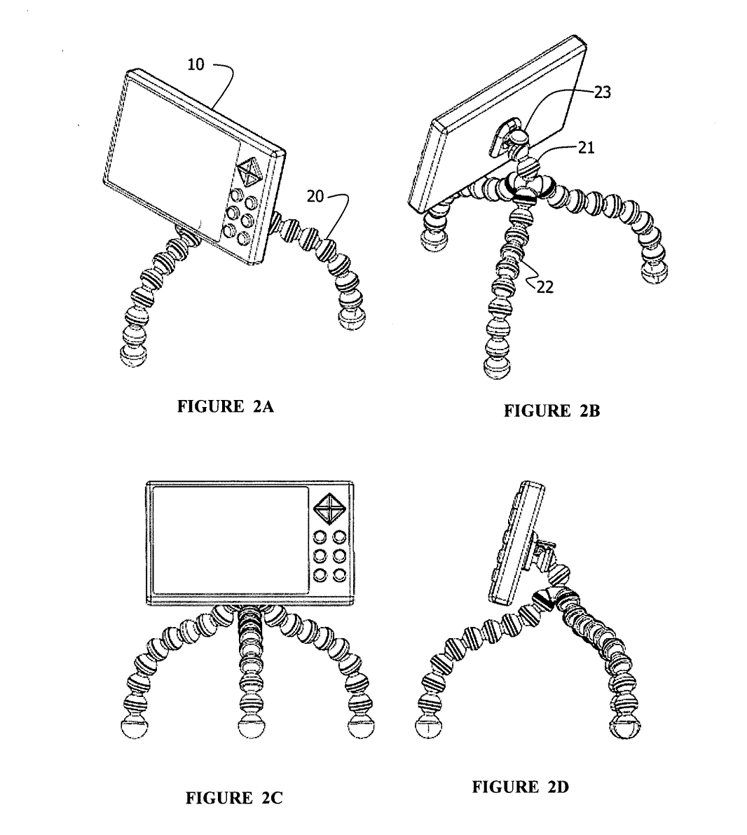

FIGS. 2A-D illustrate an electronic device 10 mounted to a flexible tripod 20 according to some embodiments of the present invention. The electronic device 10 may be attached to the interconnect portion 21 of the tripod. A release button 23 may release the mounting clip from the receiver of the interconnect portion. In some embodiments, the receiver is adapted to receive the clip and to latch a tab into the recess 14 such that although the device 10 may be easily inserted into the receiver, the tab must be pushed to allow for easy removal of the device 10 from the tripod 20.

The use of a flexible support, such as a flexible tripod, gives the distinct advantage of allowing the user to position an electronic device, such as a personal video player, in a convenient position for viewing. For example, the tripod may be placed upon a table, or an airplane seat's foldout tray, for viewing and use. The flexible legs may be used to attach and hang the device in a position where heretofore no such viewing was possible. In the case of other electronic devices, for example a baby monitor, the flexible legs of the tripod may be wrapped around the vertical ribs of a baby's crib, for example.

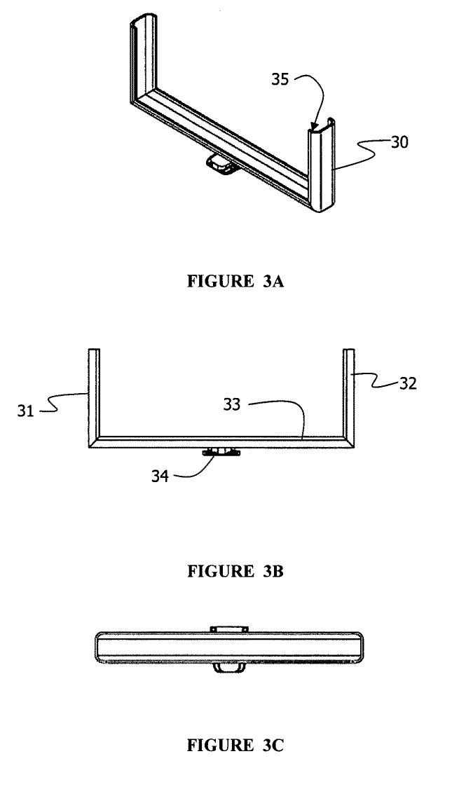

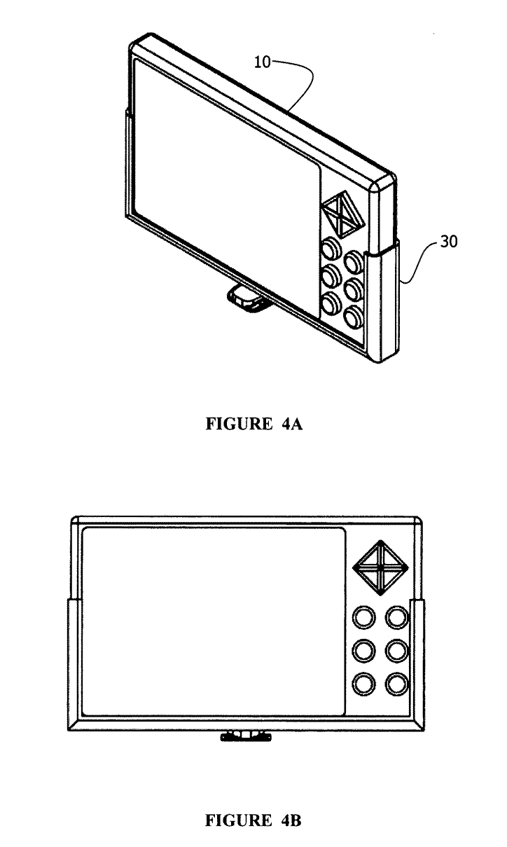

FIGS. 3A-C illustrate a device mount 30 according to some embodiments of the present invention. The device mount 30 is adapted to receive and hold an electronic device, or other device, and to allow for easy attachment and removal to a support structure, such as a flexible tripod. The device mount 30 may have a frame consisting of two side rails 31, 32 and a center rail 33. The rails may have a channel 35 with somewhat flexible yet rigid walls such that a device, such as a personal video player, may be inserted therein and be restrained within the mount to allow for attachment of the mounted device to a support structure such as a flexible tripod. FIGS. 4A-B illustrate an electronic device mounted into a device mount 30 according to some embodiments of the present invention. In some embodiments, the device mount 30 may be adapted for a particular device.

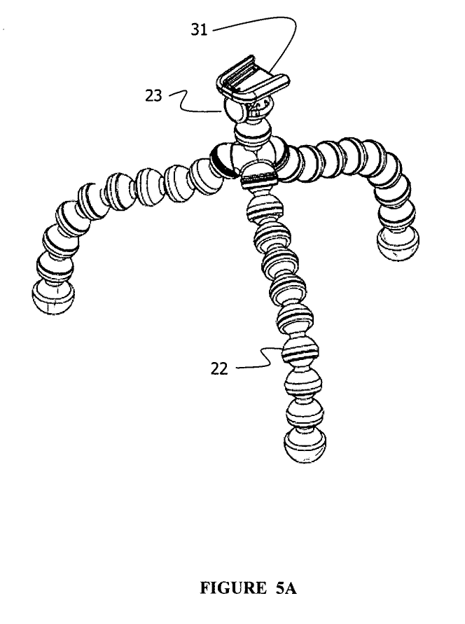

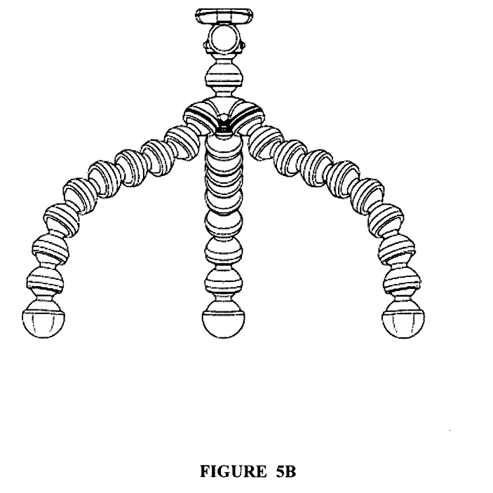

FIGS. 5A-B illustrate a flexible support structure according to some embodiments of the present invention. The tripod may have a plurality of flexible legs 22. The receiver 31 is adapted to receive a clip, which may be part of an electronic device, or may be from a mount, or other piece of apparatus.

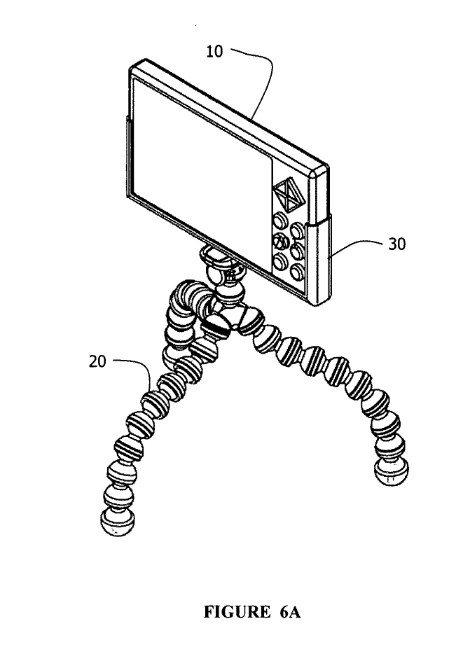

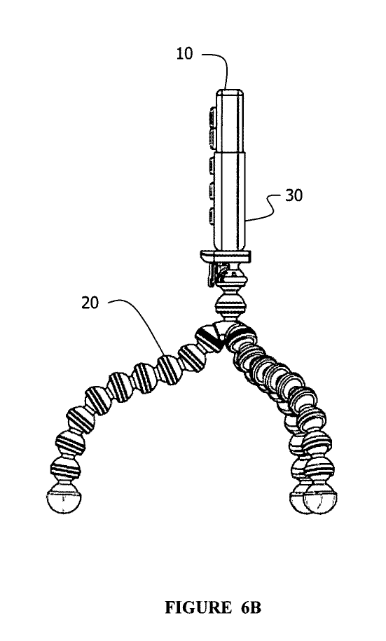

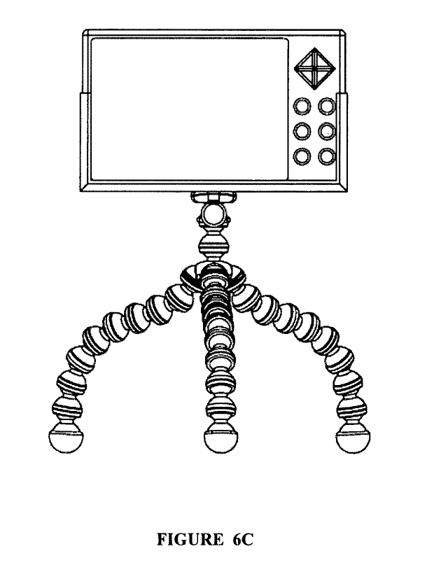

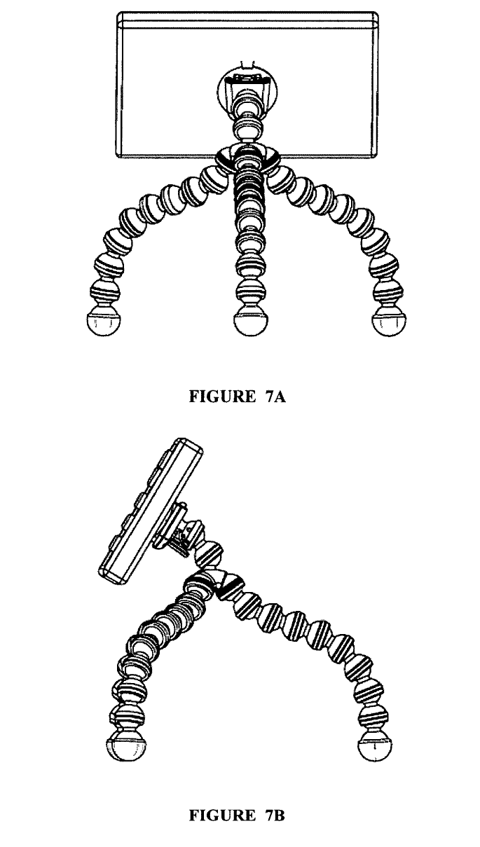

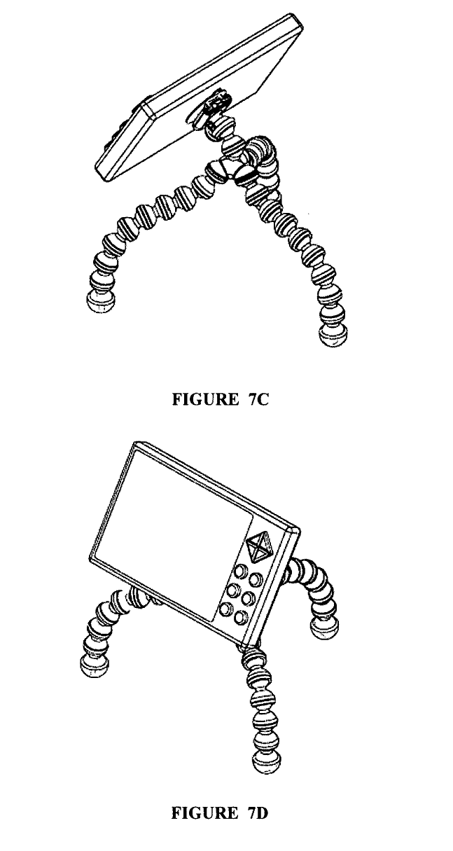

FIGS. 6A-C illustrate an apparatus assembled from an electronic device 10 mounted in a mount 30 attached to a flexible tripod 20. An apparatus such as this affords the user the convenience of using a flexible tripod as a support stand for watching video on a personal player, for example, and the use of the device mount allows the user to custom tailor their system using a mount that is designed for the player being viewed. FIGS. 7A-D illustrate an apparatus assembled from an electronic device with an integral clip mounted onto a flexible tripod according to some embodiments of the present invention.

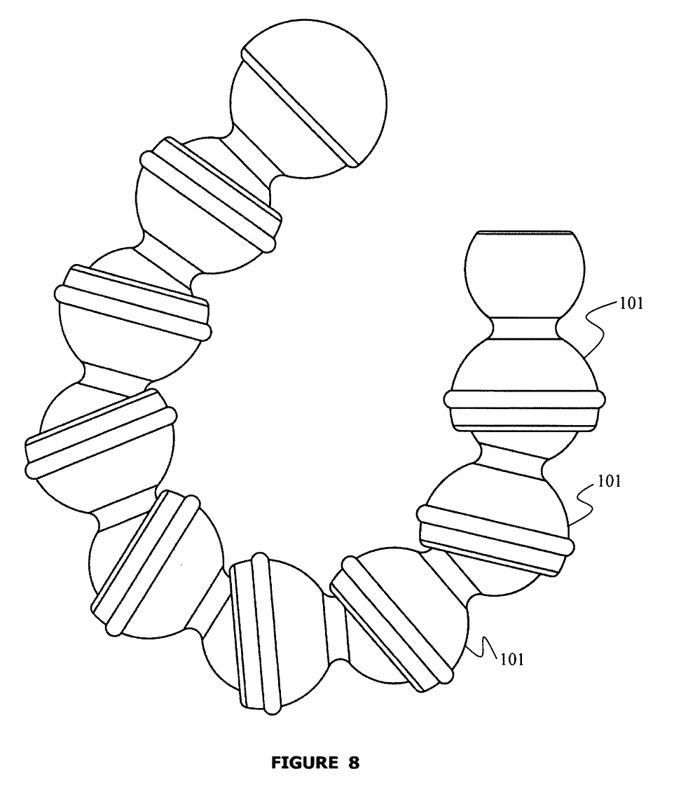

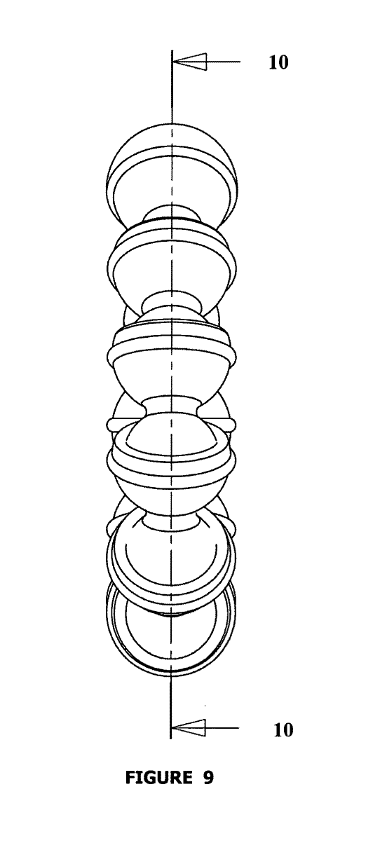

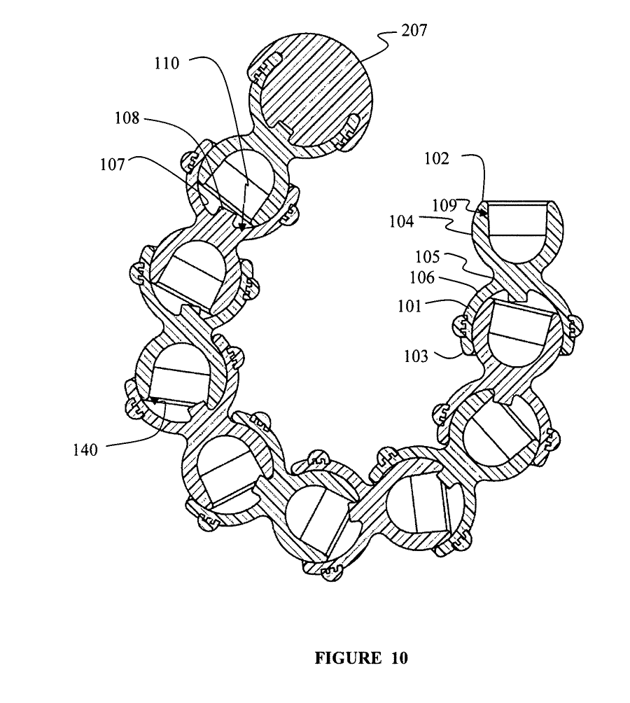

FIGS. 8, 9, and 10 illustrate a plurality of ball and socket joint connectors 101 according to some embodiments of the present invention. A connector 101 has a first end portion 102 and a second end portion 103. A socket engaging end surface 104 is present at the first end 102. The first end portion 102 is substantially hollowed out. At the end of the chain of connectors, a gripping pod 207 may be present.

The second end portion 103 has a body 106 with an internal socket receiving cavity 107. The inner surface 110 of the an internal socket receiving cavity 107 is adapted to fit over the socket engaging end surface 104 of another connector 101, or of another piece with a similar socket engaging end surface. A neckdown 105 separates the first end portion 102 from the second end portion 103. A stop nub 108 acts as a mechanical stop to prevent over angulation and possible unintentional separation of a ball and socket joint connector pair.

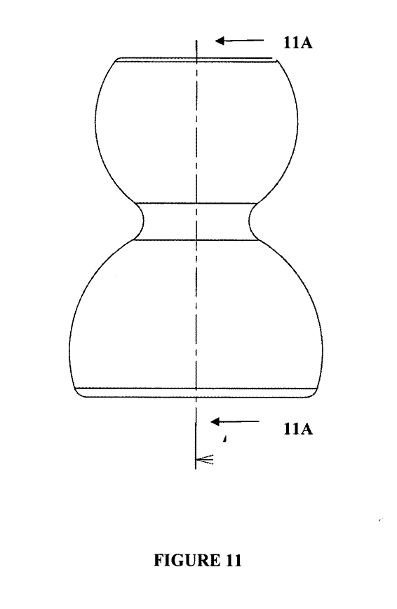

As seen in FIGS. 11 and 11A, the connector 101 has a primary axis 111 in some embodiments. The connector 101 may be symmetric around the primary axis 111 in some embodiments. The end surface planes of the first and second end portions of the connector may be perpendicular to the primary axis 111 in some embodiments.

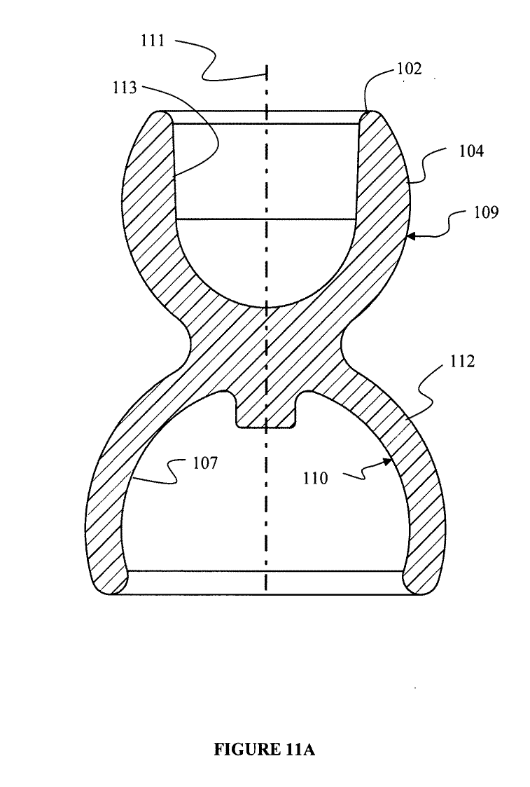

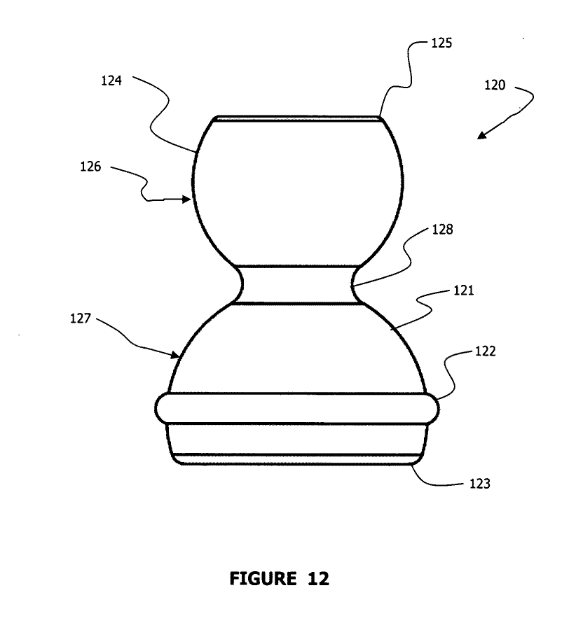

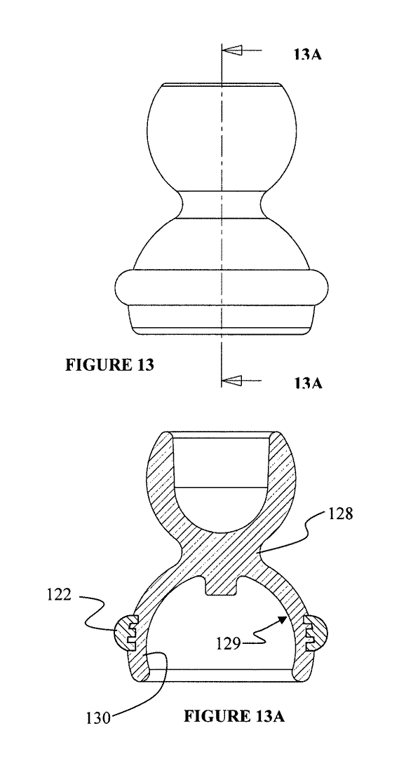

In some embodiments, as seen in FIGS. 12, 13 and 13A, a connector 120 includes a gripping portion 122. The connector 120 has a first end portion 125 and a second end portion 123. A socket engaging end surface 124 is present at the first end 125. The first end portion 125 is substantially hollowed out.

The second end 123 has a body 121 with an internal socket receiving cavity 130. The inner surface 129 of the an internal socket receiving cavity 130 is adapted to fit over the socket engaging end surface 124 of another connector, or of another piece with a similar socket engaging end surface. A neckdown 128 separates the first end portion 125 from the second end portion 123. A gripping portion 122 allows the connector to grip surfaces more readily. In some embodiments, the gripping portion is co-molded into the connector body. In some embodiments, the gripping portion is a rubberized compound. In some embodiments, the gripping portion is a circumferential ring molded into the outer surface of the connector. The gripping portion may provide a higher friction interface when the connector is set upon or wrapped around an object.

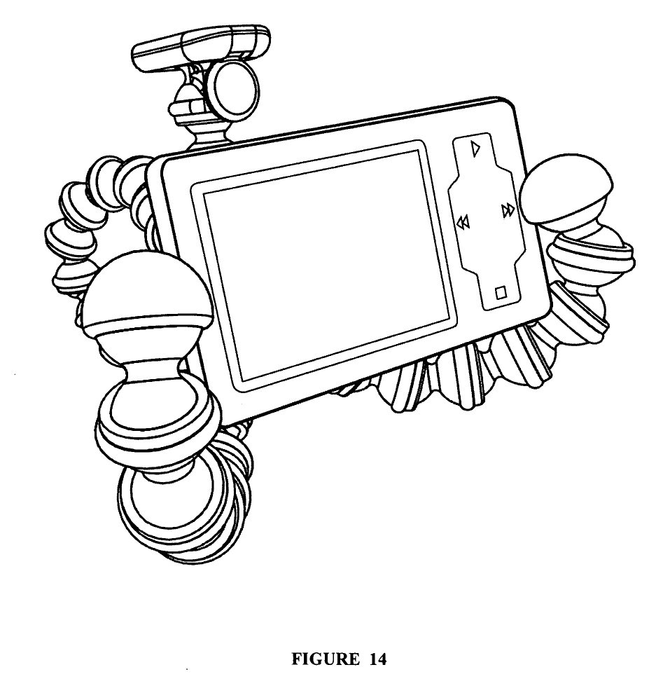

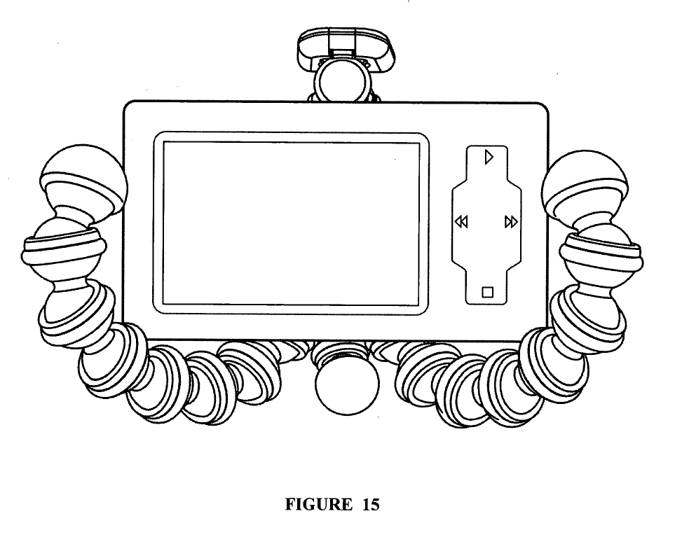

FIGS. 14 and 15 illustrate the use of a flexible tripod used to hold and position a video player in a position that allows a user to view the device.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

I claim:

1. An apparatus comprising:
an electronic device, said electronic device removeably connected to a flexible tripod, said electronic device comprising a clip; and
a flexible tripod, said flexible tripod comprising:
a body portion;
an interconnect portion connected to said body portion; and
a plurality of flexible legs, said flexible legs comprising a first end and a second end, said first end connected to said body portion;
wherein said interconnect portion comprises a receiver adapted to receive said clip.

2. The apparatus of claim 1 wherein each of said plurality of flexible legs comprises a plurality of connectors, said connectors comprising:
a connector body, said connector body comprising:
a first end portion;
a second end portion; and
a socket engaging end surface at said first end portion, said socket engaging end surface being the external surface at said first end portion;
an internal socket receiving cavity at said second end portion.

3. The apparatus of claim 2 wherein said connectors further comprise a gripping portion, said gripping portion located around the outer periphery of said first portion.

4. The apparatus of claim 1 wherein said receiver comprises a spring loaded tab adapted to capture said clip.

5. The apparatus of claim 4 wherein said clip comprises a recess in its bottom surface, said recess adapted to fit said spring loaded tab when said clip is attached to said receiver of said interconnect portion.

6. The apparatus of claim 2 wherein said electronic device is a video player.

7. An apparatus comprising:
an electronic device, said electronic device attached to a flexible tripod; and
a flexible tripod, said flexible tripod comprising:
a body portion;
an interconnect portion connected to said body portion; and
a plurality of flexible legs, said flexible legs comprising a first end and a second end, said first end connected to said body portion;
wherein said electronic device is attached to said interconnect.

8. The apparatus of claim 7 wherein each of said plurality of flexible legs comprises a plurality of connectors, said connectors comprising:
a connector body, said connector body comprising:
a first end portion;
a second end portion; and
a socket engaging end surface at said first end portion, said socket engaging end surface being the external surface at said first end portion;
an internal socket receiving cavity at said second end portion.

9. The apparatus of claim 8 wherein said connectors further comprise a gripping portion, said gripping portion located around the outer periphery of said first portion.

10. The apparatus of claim 8 wherein said electronic device is a video player.

11. An apparatus comprising:
an electronic device, said electronic device removeably attached to a device mount;
a device mount, said device mount removeably connected to a flexible tripod, said device mount comprising a clip; and
a flexible tripod, said flexible tripod comprising:
a body portion;
an interconnect portion connected to said body portion; and
a plurality of flexible legs, said flexible legs comprising a first end and a second end, said first end connected to said body portion;
wherein said interconnect portion comprises a receiver adapted to receive said clip.

12. The apparatus of claim 11 wherein each of said plurality of flexible legs comprises a plurality of connectors, said connectors comprising:
a connector body, said connector body comprising:
a first end portion;
a second end portion; and
a socket engaging end surface at said first end portion, said socket engaging end surface being the external surface at said first end portion;
an internal socket receiving cavity at said second end portion.

13. The apparatus of claim 12 wherein said connectors further comprise a gripping portion, said gripping portion located around the outer periphery of said first portion.

14. The apparatus of claim 11 wherein said receiver comprises a spring loaded tab adapted to capture said clip.

15. The apparatus of claim 14 wherein said clip comprises a recess in its bottom surface, said recess adapted to fit said spring loaded tab when said clip is attached to said receiver of said interconnect portion.

16. The apparatus of claim 12 wherein said electronic device is a video player.
